(19) United States
(12) Patent Application Publication
(10) Pub. No.: US 2014/0268797 A1
(43) Pub. Date: Sep. 18, 2014

(54) LIGHT ASSEMBLY

(71) Applicant: ABL IP HOLDING LLC, Conyers, GA (US)

(72) Inventors: Algimantas J. Gabrius, Oxford, GA (US); Douglas Dewayne Grove, Grayson, GA (US); Joseph J. Onda, Covington, GA (US); Carl Jason Schoeneberg, Decatur, GA (US); Paul Gregory Thompson, Ecru, MS (US)

(73) Assignee: ABL IP HOLDING LLC, Conyers, GA (US)

(21) Appl. No.: 13/803,743

(22) Filed: Mar. 14, 2013

(51) Int. Cl. F21V 17/00; F21V 17/10; F21V 29/00

(52) U.S. Cl. CPC F21V 17/002; F21V 29/2206; F21V 17/10
USPC 362/294; 362/341; 362/345; 362/346; 362/328

(57) ABSTRACT

A light engine that allows for customization and easy adjustability of various properties of the distributed light. The light engine includes an optic holder having threads that engage with threads of a mounting ring to allow a lower reflector and/or a diffuser lens to be replaced without removing the entire light engine from the installation. The light engine also includes an upper reflector that interfaces with the optic holder so that the upper reflector also can be easily replaced without removing the entire light engine from the installation.

### FIELD OF THE INVENTION

Embodiments of the invention generally relate to a light assembly for recessed positioning within a ceiling.

### BACKGROUND OF THE INVENTION

Conventional downlight fixtures use light emitting diodes (“LEDs”) or other suitable light sources. Because LEDs and other light sources give off thermal energy, heat sinks are sometimes incorporated into the fixture to facilitate heat dissipation from the light sources. The downlight fixture also typically includes one or more reflectors and one or more diffuser lenses that help diffuse and direct the light as desired. To alter the output and distribution of the light source (such as its beam angle, diffusing light pattern, color, etc.), the entire assembly must be removed from the ceiling, which is time consuming and cumbersome.

### SUMMARY OF THE INVENTION

The terms “invention,” “the invention,” “this invention” and “the present invention” used in this patent are intended to refer broadly to all of the subject matter of this patent and the patent claims below. Statements containing these terms should not be understood to limit the subject matter described, herein or to limit the meaning or scope of the patent claims below. Embodiments of the invention covered by this patent are defined by the claims below, not this summary. This summary is a high-level overview of various aspects of the invention and introduces some of the concepts that are further described, in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

In certain embodiments, a versatile light engine for recessed positioning in a ceiling is provided that allows for quick and easy customization of the light engine's light output and distribution without having to remove the light engine from the installation in some embodiments, the light engine includes an optic holder with threads that engage threads of a mounting ring coupled to a lower reflector. In some embodiments, the light engine also includes an upper reflector that releasably interfaces with the optic holder. Due to the configuration of the light engine, the upper reflector and/or the lower reflector and/or the diffuser lens can be easily replaced without having to remove the light engine from the installation.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is an assembled perspective view of a light engine according to one embodiment mounted on a mounting frame.

FIG. 2 is an exploded view of the light engine of FIG. 1.

FIG. 3 is an assembled view of the light engine of FIG. 2.

FIG. 4 is an exploded view of the optic assembly of the light engine of FIG. 2 positioned relative to the optic holder of the light engine of FIG. 2.

FIG. 5 is an assembled view of the optic assembly of FIG. 4.

### DETAILED DESCRIPTION OF THE DRAWINGS

The subject matter of embodiments of the present invention is described here with specificity to meet statutory requirements, but this description is not necessarily intended, to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of a light assembly (one embodiment of which is shown assembled in FIG. 1) include a pan or mounting frame 12 on which a light engine 14 is mounted so as to direct light through an opening of the frame 12 and out of an opening in the ceiling.

As shown in FIGS. 2 and 3, embodiments of the light engine 14 include a heat sink 18 and a light source 20 mounted to the underside of the heat sink 18 so that light emitted from the light source 20 is directed downwardly away from the heat sink 18. The light source 20 in the illustrated embodiment includes a chip-on-board light emitting diode array 22a mounted on a printed circuit board (PCB) 22b, however the light source 20 is certainly not limited to such an embodiment. Rather, any light source 20 is contemplated herein and may be selected based on the desired lumen output and correlated color temperature of the engine. Fins 17 may, but do not have to, extend radially from the heat sink 18 to enhance convective cooling of heat dissipated through heat sink 18. The dimensions of heat sink 18, including its height, may vary depending on the thermal needs of the light source. Embodiments of the invention are certainly not intended to be limited to the exact light engine 14 illustrated in the attached figures.

Light engine 14 also includes an optic holder 24 mounted below the heat sink 18. In some embodiments, optic holder 24 attaches to the heat sink 18 or light source 20 (such as the PCB 22h) with mechanical fasteners or in any suitable way. A passageway 50 extends entirely through the optic holder 24 so as to define an inner surface 52. When the optic holder 24 is mounted below the heat sink 18, light from the light source 20 is emitted through the passageway 50 of the optic holder 24. Fins 17 may be, but do not have to be, provided on the outer wall 54 of the optic holder 24 to facilitate heat dissipation from the light engine 14. In some embodiments, optic holder 24 is formed of cast metal, although it may be formed of any suitable material.

A plurality of threads 26 are provided, on the outer surface of the optic holder on an end of the optic holder 24 distal the heat sink 18. While the threads 26 are shown extending around the outer surface of the optic holder 24, in some embodiments they extend around the inner surface 52 of the optic holder 24.

FIGS. 4 and 5 show exploded and assembled views, respectively, of one embodiment of optic assembly 28. The optic assembly 28 includes an upper reflector 30, diffuser 34, and a lower reflector 36. In some embodiments, upper reflector 30 may be formed of any material (such as metal or plastic) and includes an inner reflective surface to reflect light emitted by the light source 20. The upper reflector 30 is positioned and retained at least partially within the passageway 50 of the optic holder 24 such that an opening 60 (FIGS. 4-5) at the top of the upper reflector 30 aligns with the light source(s) 20 so that light from the light source(s) 20 is emitted into the upper reflector 30. While the upper reflector 30 may be retained with the optic holder with mechanical fasteners, in some embodiments such fasteners are not needed. For example, in the illustrated embodiment, grooves 48 extend along the height of the inner surface 52 of the optic holder 24 and wings 46 extend radially from an upper end of the upper reflector 30. It may be desirable that the cross-sectional shape of the grooves 48 and the wings 46 are the same, but that is not required. To insert the upper reflector 30 within the optic holder 24, the wings 46 are aligned with the grooves 48 to permit insertion of the upper reflector 30 into the optic holder 24 until the wings 46 clear the upper surface 56 of the optic holder 24. To retain the upper reflector 30 within the optic holder 24, the reflector is rotated so that the wings 46 rest atop the optic holder 24 (such as the upper surface 56 of the optic holder 24).

This configuration allows for easy installation and removal of the upper reflector 30 within and from the optic holder 24 without the use of tools. This tool-less assembly and disassembly also allows the upper reflector 30 to be easily replaced with a different upper reflector having different optical properties thereby to adjust the beam angle and other properties of the light distribution. Tabs 32 or other retention features may be provided on the upper reflector 30 to bear against the inner surface 52 of the optic holder 24 to prevent the upper reflector 30 from inadvertently rotating relative to, and disengaging from, the optic holder 24, thus ensuring the upper reflector 30 remains in a locked, position without requiring use of fasteners or other separate components or tools.

Optic assembly 28 also includes a lower reflector 36, which may be a metal or plastic reflector having a reflective inner surface. In some embodiments, the lower reflector 36 is generally in the shape of a truncated cone, however the lower reflector 36 is not intended to be limited to such a shape. Lower reflector 36 includes a mounting ring 40, which can be formed integrally with the lower reflector 36 or, in other embodiments, is a separate component that is attached by adhesive or any other suitable means to lower reflector 36. A plurality of threads 38 is provided on the inner surface of the mounting ring 40, although in other embodiments such threads may be provided, on an outer surface of the mounting ring 40.

A diffuser lens 34, having optical properties to distribute the emitted light as desired, is interposed between the upper reflector 30 and lower reflector 36. In some embodiments, diffuser lens 34 is attached to the upper reflector 30 using adhesive, mechanical snaps and/or fasteners, or by any other suitable means. In other embodiments, diffuser lens 34 is retained within the optic assembly 28 by the lower reflector 36. For example, the lower reflector 36 or mounting ring 40 may include a ledge 58 upon which the diffuser lens 34 can rest so as to be supported in the optic assembly 28.

The threads 38 on the mounting ring 40 of the lower reflector 36 engage with the threads 26 on the optic holder 24 to attach the lower reflector 36 to the optic holder 24. Mounting rings 40 of different heights may be provided on the lower reflector 36 to accommodate positioning and retention of other optical attachments (e.g., lenses, louvers, filter assemblies and the like) within the mounting ring 40 to further distribute the emitted light as desired.

Use of the mounting ring 40 allows for quick and easy customization of the light output of the light engine 14. For example, the lower reflector 36 can be replaced with a lower reflector having different optical properties simply by unscrewing the mounting ring 40 from the optic holder 24. Similarly, removal of the mounting ring 40/lower reflector 36 allows access to the upper reflector 30, which can easily be replaced as discussed above. Finally, the diffuser lens 34 and other optical attachments can be substituted for others having different optical properties by simply disengaging the mounting ring 40 from the optic holder 24. All of these replacements/substitutions can occur quickly and without the need for tools. In this way, the beam angle, beam intensity, diffusing light pattern, light output, color, focusing, etc. may be adjusted in nearly any conceivable combination without having to remove the light engine 14 from the installation.

In some embodiments, the light engine 14 is retained on the mounting pan 12 by torsions springs 42 mounted on mounting arms 44 that are attached to the light engine 14 (such as, but not limited to, the optic holder, as shown in FIG. 1).

The foregoing is provided for purposes of illustrating, explaining, and describing embodiments of the present invention. Further modifications and adaptations to these embodiments ents will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

We claim:

1. A light engine comprising:
a. a heat sink;
b. a light source mounted to the heat sink and positioned to emit light from an underside of the heat sink;
c. an optic holder mounted below the heat sink and haying an upper surface positioned adjacent the heat sink, an outer wall, and a passageway extending through the optic holder so as to define an inner surface, wherein the optic holder comprises a first set of threads; and
d. an optic assembly comprising:
i. an upper reflector haying a reflective inner surface, wherein the upper reflector is retained by the optic holder such that light from the light source is emitted into the upper reflector, wherein at least two wings extend from the upper reflector and abut the upper surface of the optic holder to retain the upper reflector within the optic holder; and
ii. a lower reflector comprising a mounting ring haying a second set of threads, wherein the lower reflector is retained on the optic holder by engagement of the second set of threads with the first set of threads.

2. The light engine of claim 1, wherein the first set of threads extends at least partially around the outer wall of the optic holder and the second set of threads extends at least partially around an inner wall of the mounting ring.

3. The light engine of claim 1, wherein the upper reflector further comprises a plurality of tabs configured to bear against the inner surface of the optic holder to prevent the upper reflector from rotating relative to the optic holder.

4. The light engine of claim 1, wherein the optic holder further comprises at least two grooves formed in the inner surface.

5. The light engine of claim 4, wherein a cross-sectional shape of the at least two grooves is substantially the same as a cross-sectional shape of the at least two wings.

6. The light engine of claim 1, wherein the optic assembly further comprises a diffuser lens interposed between the upper reflector and the lower reflector.

7. The light engine of claim 1, wherein the optic holder further comprises a plurality of fins extending radially from the outer wall.

8. The light engine of claim 1, wherein the light source comprises a plurality of light emitting diodes.

9. A light engine comprising:
a. an optic holder having an upper surface, an outer wall, and a passageway extending through the optic holder so as to define an inner surface haying a height; and
b. an upper reflector haying a reflective inner surface and comprising (i) at least two wings that extend from the upper reflector and (ii) a plurality of tabs, wherein the at least two wings abut the upper surface of the optic holder to retain the upper reflector within the optic holder, and wherein the plurality of tabs bear against the inner surface of the optic holder to prevent rotation of the upper reflector within the optic holder.

10. The light engine of claim 9, further comprising a heat sink mounted above the optic holder and a light source mounted to an underside of the heat sink.

11. The light engine of claim 9, further comprising a lower reflector having a first set of threads, wherein the optic holder comprises a second set of threads and wherein the lower reflector is retained on the optic holder by engagement of the first set of threads with the second set of threads.

12. The light engine of claim 11, further comprising a diffuser lens interposed between the upper and lower reflectors.

13. The light engine of claim 12, wherein the diffuser lens seats on a ledge in the lower reflector.

14. The light engine of claim 11, wherein the lower reflector comprises a mounting ring having an inner surface and wherein the first set of threads are provided on the inner surface of the mounting ring.

15. The light engine of claim 9, wherein a plurality of grooves are defined in the inner surface of the optic holder and extend along the height of the inner surface, wherein each of the plurality of grooves is configured to receive one of the at least two wings of the upper reflector.

16. The light engine of claim 15, wherein a cross-sectional shape of the at least two grooves is substantially the same as a cross-sectional shape of the at least two wings.

17. A method of securing a reflector having at least two wings to an optic holder having an upper surface, an outer wall, a passageway extending through the optic holder so as to define an inner surface, and at least two grooves extending along the inner surface, the method comprising:
a. aligning the at least two wings of the reflector with the at least two grooves of the optic holder;
b. inserting the reflector into the optic holder by sliding the at least two wings within the at least two grooves until the at least two wings are located above the upper surface of the optic holder; and
c. rotating the reflector relative to the optic holder such that the at least two wings abut an upper surface of the optic holder to retain the reflector within the optic holder.

18. The method of claim 17, wherein rotating the reflector to retain the reflector within the optic holder causes one or more tabs extending from the reflector to bear against the inner surface of the optic holder to prevent rotation of the reflector relative to the optic holder.

19. The method of claim 17, further comprising mounting an additional reflector on the optic holder by engaging a first set of threads on the additional reflector with a second set of threads on the optic holder.

20. The method of claim 15, further comprising mounting the optic holder below a heat sink.
